(19) United States
(12) Patent Application Publication
(10) Pub. No.: US 2007/0086065 A1
(43) Pub. Date: Apr. 19, 2007

(54) Image data transmitting apparatus

(75) Inventor: Masahiro Wada, Kyoto (JP)

Correspondence Address: EDWARDS & ANGELL, LLP, P.O. BOX 55874, BOSTON, MA, 02205, US

(73) Assignee: Sharp Kabushiki Kaisha, Osaka (JP)

(21) Appl. No.: 11/581,962

(22) Filed: Oct. 16, 2006

(30) Foreign Application Priority Data
Oct. 17, 2005 (JP) 2005-302106

(51) Int. Cl. H04N 1/00

(52) U.S. Cl. 358/402

(57) ABSTRACT

An image data transmitting apparatus, which comprises transmitting means for transmitting image data to outside and setting means for setting one or a plurality of destinations of image data to be transmitted by the transmitting means, for transmitting image data to one or a plurality of set destinations, comprising means for determining whether a set destination is a destination which follows a predetermined rule or not and annunciating means for annunciating the fact when it is determined that the set destination is not a destination which follows the rule.

### CROSS-REFERENCE TO RELATED APPLICATIONS

This Nonprovisional application claims priority under 35 U.S. C. §119(a) on Patent Application No. 2005-302106 filed in Japan on Oct. 17, 2005, the entire contents of which are hereby incorporated by reference.

### BACKGROUND OF THE INVENTION

1. Field of the Invention

The present invention relates to an image data transmitting apparatus in which the destination can be set using a one-touch key.

2. Description of Related Art

Conventionally proposed is an image transmitting apparatus wherein information on each destination, such as the telephone number, the facsimile number or the email address, is registered for one hardware or software key (which will be hereinafter referred correctively to as a one-touch key) in advance, and the registered information on the destination is read out and a transmission process is initiated when the one-touch key is selected (see Japanese Patent Application Laid-Open No. S60-96951 (1985), for example).

With such an image transmitting apparatus wherein the destination is decided by selecting a one-touch key, it is possible to save the effort of entering the destination individually using character entering keys and an environment more convenient than entering the destination individually can be provided.

Moreover, developed recently is an image transmitting apparatus using an email function, such as an Internet facsimile, which is getting more users with the spread of the network environment since a process from scanning of the original copy to transmission of image data can be performed smoothly.

In a conventional facsimile machine wherein there is a time lag between initiation of dial callout and completion of actual connection, it is possible to stop the transmission process in the middle thereof if the user notices a mistake of the destination in the middle of transmission even when a one-touch key is used. However, in transmission of image data using an email function described above wherein a transmission process is completed promptly, there is a problem that information might be leaked when the destination is set improperly or when the destination is selected improperly.

### BRIEF SUMMARY OF THE INVENTION

An image data transmitting apparatus according to the present invention is an image data transmitting apparatus, which comprises transmitting means for transmitting image data to outside and setting means for setting one or a plurality of destinations of image data to be transmitted by the transmitting means, for transmitting image data to one or a plurality of set destinations, characterized by comprising means for determining whether a set destination is a destination which follows a predetermined rule or not and annunciating means for annunciating that the set destination is not a destination which follows the rule when it is determined that the set destination is not a destination which follows the rule.

In the present invention, the fact is annunciated when a destination of the image data is not a destination which follows a predetermined rule. Accordingly, an advance notice is given to the user when it can be determined that the destination is improper or the like.

An image data transmitting apparatus according to the present invention is an image data transmitting apparatus, which comprises transmitting means for transmitting image data to outside and setting means for setting one or a plurality of destinations of image data to be transmitted by the transmitting means, for transmitting image data to one or a plurality of set destinations, characterized by comprising means for determining whether a plurality of destinations have been set by the setting means or not, means for determining whether set destinations are a combination which follows a predetermined rule or not when it is determined that a plurality of destinations have been set and annunciating means for annunciating that the set destinations are not a combination which follows the rule when it is determined that the set destinations are not a combination which follows the rule.

In the present invention, the fact is annunciated when a combination of destinations of image data is not a combination which follows a predetermined rule. Accordingly, an advance notice is given to the user when a mistake might be included in the destination or the like.

An image data transmitting apparatus according to the present invention is characterized in that the transmitting means is constructed to transmit image data using a communication address including a domain name and the rule is that a communication address of a set destination does not include a domain name different from a source.

In the present invention wherein determination is made using a rule that a communication address of a destination of image data does not include a domain name different from the source, an advance notice is not given to the user when the source and the destination have the same domain name but is given to the user only when image data is transmitted to a destination which has a domain name different from the source.

An image data transmitting apparatus according to the present invention is characterized in that the transmitting means is constructed to transmit image data using a communication address including a domain name and the rule is that set destinations do not include different kinds of domain names.

In the present invention wherein determination is made using a rule that different kinds of domain names are not included in a combination of a plurality of set destinations, an advance notice is given to the user when domain names of a plurality of kinds are mixed.

An image data transmitting apparatus according to the present invention is characterized in that the transmitting means is constructed to transmit image data using an email address and the rule is that set destinations do not include different kinds of domain names.

In the present invention wherein determination is made using a rule that email addresses having different kinds of domain names are not included in a combination of a plurality of set destinations, an advance notice is given to the user when domain names of a plurality of kinds are mixed.

An image data transmitting apparatus according to the present invention is characterized by comprising means for storing a name allocated to each destination in association with a communication address of each destination, means for displaying a plurality of names of destinations and means for accepting selection of a name or names of one or a plurality of destinations from displayed names of destinations, wherein a communication address associated with a name of a selected destination is set as a destination.

In the present invention, a name allocated to each destination is displayed, selection of a name or names of one or a plurality of destinations from displayed names of destinations is accepted and a communication address allocated to a name of a selected destination is set as a destination. Accordingly, it is no longer necessary to directly enter a facsimile number, an IP address, an email address or the like.

An image data transmitting apparatus according to the present invention is characterized in that the annunciating means has means for displaying textual information indicating that a set destination is to be confirmed.

In the present invention, the annunciating means for giving an advance notice displays textual information indicating that a set destination is to be confirmed.

An image data transmitting apparatus according to the present invention is characterized in that the annunciating means has means for explicitly displaying a destination to be confirmed.

In the present invention, the annunciating means for giving an advance notice explicitly displays a destination to be confirmed.

An image data transmitting apparatus according to the present invention is characterized by comprising reading means for reading an image of an original copy and means for generating an email including image data obtained by the reading means, wherein a generated email is transmitted to a set destination.

In the present invention, image data to be transmitted is transmitted while being attached to an email.

With the present invention, the fact is annunciated when a destination of image data is not a destination which follows a predetermined rule. Accordingly, an advance notice is given to the user when it can be determined that the destination is improper or the like, so that it is possible to prompt reconfirmation of the destination.

With the present invention, the fact is annunciated when a combination of destinations of image data is not a combination which follows a predetermined rule. Accordingly, an advance notice is given to the user when a mistake might be included in the destination or the like, so that it is possible to prompt reconfirmation of the destination.

With the present invention, determination is made using a rule that a communication address of a destination of image data does not include a domain name different from the source. Accordingly, an advance notice is not given to the user when the source and the destination have the same domain name but is given to the user only when image data is transmitted to a destination which has a domain name different from the source. That is, an advance notice is not given when it can be determined that the destination belongs to the same organization but is given when it can be determined that the destination belongs to another organization, so that it is possible to prevent improper leakage of information.

With the present invention, determination is made using a rule that different kinds of domain names are not included in a combination of a plurality of set destinations. Accordingly, an advance notice is given to the user when domain names of a plurality of kinds are mixed. That is, an advance notice is given to prompt reconfirmation when a destination of a person who does not belong to the same organization is partially included, so that it is possible to prevent improper leakage of information.

With the present invention, determination is made using a rule that email addresses having different kinds of domain names are not included in a combination of a plurality of set destinations. Accordingly, an advance notice is given to the user when domain names of a plurality of kinds are mixed. That is, an advance notice is given to prompt reconfirmation when a destination of a person who does not belong to the same organization is partially included, so that it is possible to prevent improper leakage of information.

With the present invention, a name allocated to each destination is displayed, selection of a name or names of one or a plurality of destinations from displayed names of destinations is accepted and a communication address allocated to a name of a selected destination is set as a destination. Accordingly, it is no longer necessary to directly enter a facsimile number, an IP address, an email address or the like.

With the present invention, textual information indicating that a set destination is to be confirmed is displayed and it is possible to prompt reconfirmation when it can be determined that a mistake is included in the destination.

With the present invention, a destination to be confirmed is explicitly displayed and it is possible to prompt reconfirmation of the destination to the user.

With the present invention, image data to be transmitted is transmitted while being attached to an email. Accordingly, the present invention can be applied to a digital multi-function peripheral having a transmitting/receiving function of an email or an Internet facsimile.

The above and further objects and features of the invention will more fully be apparent from the following detailed description with accompanying drawings.

### BRIEF DESCRIPTION OF THE SEVERAL VIEWS OF THE DRAWINGS

FIG. 1 is a schematic view showing the entire structure of an image data transmitting/receiving system which is established using a digital multi-function peripheral according to the present embodiment;

FIG. 2 is a block diagram for explaining the internal structure of the digital multi-function peripheral;

FIG. 3 is a conceptual diagram showing an example of an own address registration unit and a destination management table;

FIG. 4 is a schematic view showing an example of an operation panel;

FIG. 5 is a schematic view showing an example of a destination setting screen to be displayed in setting of a destination using a one-touch key;

FIG. 6 is a schematic view showing an example of a destination setting screen to be displayed in setting of a destination using a one-touch key;

FIGS. 7A and 7B are explanatory views for explaining the operation of a digital multi-function peripheral according to the present embodiment;

FIG. 8 is a schematic view for explaining an example of execution of a confirmation process;

FIG. 9 is a schematic view for explaining another example of execution of a confirmation process;

FIGS. 10A and 10B are a flow chart for explaining the procedure of a process to be executed by the digital multi-function peripheral;

FIGS. 11A and 11B are explanatory views for explaining another example of criterion;

FIGS. 12A and 12B are explanatory views for explaining another example of criterion;

FIGS. 13A and 13B are explanatory views for explaining the operation of a digital multi-function peripheral according to the present embodiment; and

FIG. 14 is a flow chart for explaining the process procedure of the digital multi-function peripheral.

### DETAILED DESCRIPTION OF THE INVENTION

The following description will explain embodiments of an image data transmitting apparatus according to the present invention applied to a digital multi-function peripheral in detail with reference to the drawings illustrating some embodiments thereof.

Embodiment 1

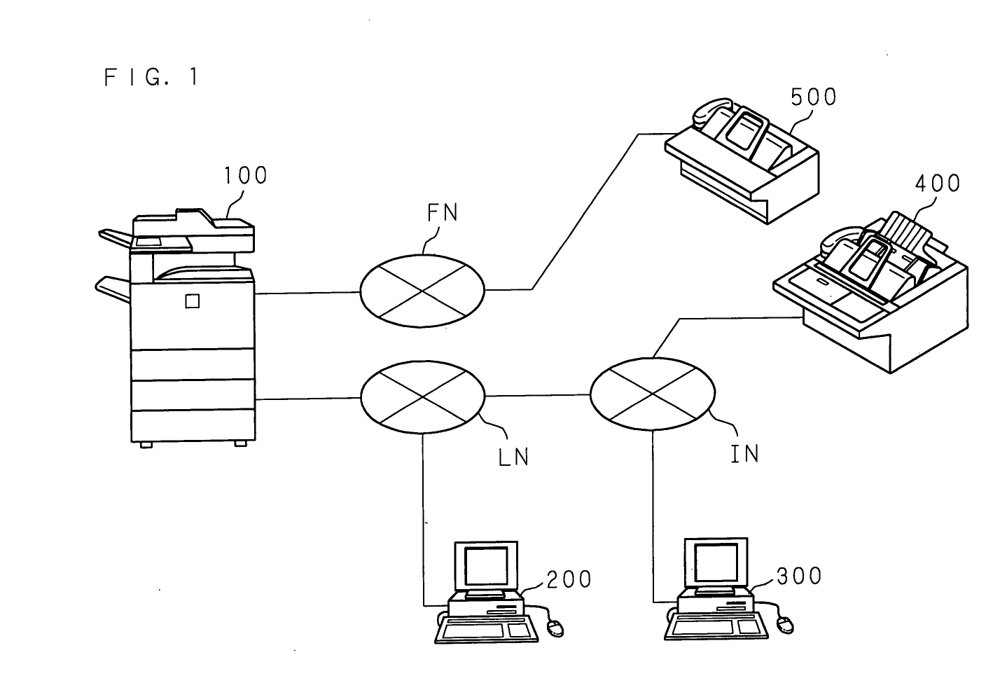

FIG. 1 is a schematic view showing the entire structure of an image data transmitting/receiving system which is established using a digital multi-function peripheral according to the present embodiment. Denoted at 100 in the figure is a digital multi-function peripheral having a scanning function, a copying function, a printing function, a facsimile transmitting/receiving function, an email transmitting/receiving function and the like. The digital multi-function peripheral 100 is connected with various kinds of external equipments via communication networks. For example, the digital multi-function peripheral 100 is connected with a personal computer 200 via a local area network LN. The local area network LN is also connected with an Internet network IN via a gateway device or the like which is not illustrated in the figure and connected with a personal computer 300 and an Internet facsimile machine 400 via the Internet network IN. The digital multi-function peripheral 100 is further connected with a facsimile machine 500 via a facsimile communication network FN.

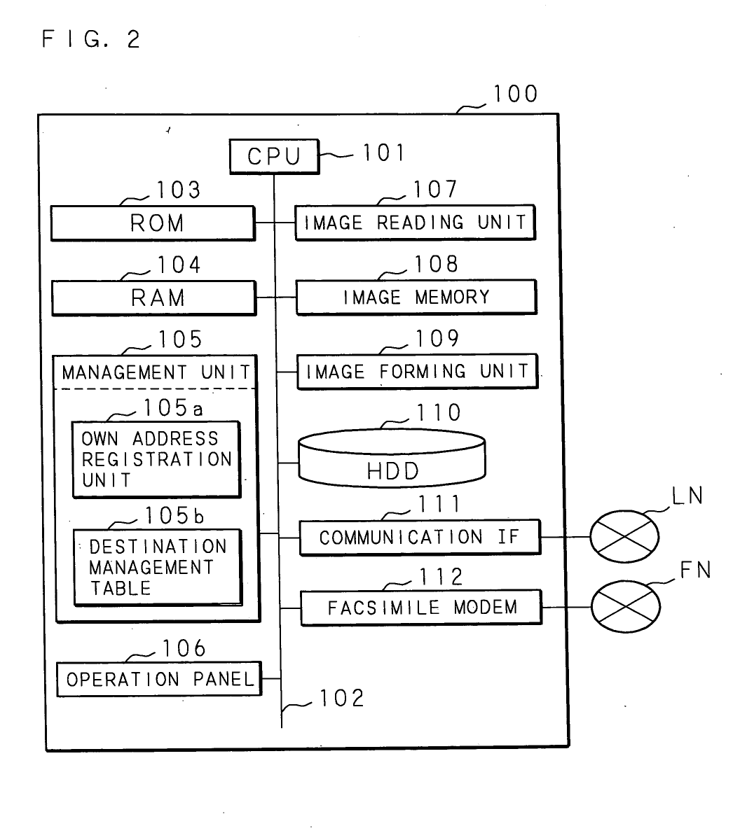

FIG. 2 is a block diagram for explaining the internal structure of the digital multi-function peripheral 100. The digital multi-function peripheral 100 comprises a CPU 101, which loads a control program prestored in a ROM 103 to a RAM 104 and executes the control program, so as to control various kinds of hardware connected via a bus 102 and cause the entire structure to function as an image data transmitting apparatus according to the present invention.

The following description will explain the structure of various kinds of hardware connected with the bus 102. A management unit 105 is constituted of a nonvolatile semiconductor memory and a part of the storage area thereof is used as an own address registration unit 105a for registering its own communication address and a destination management table 105b for managing communication addresses of external equipments.

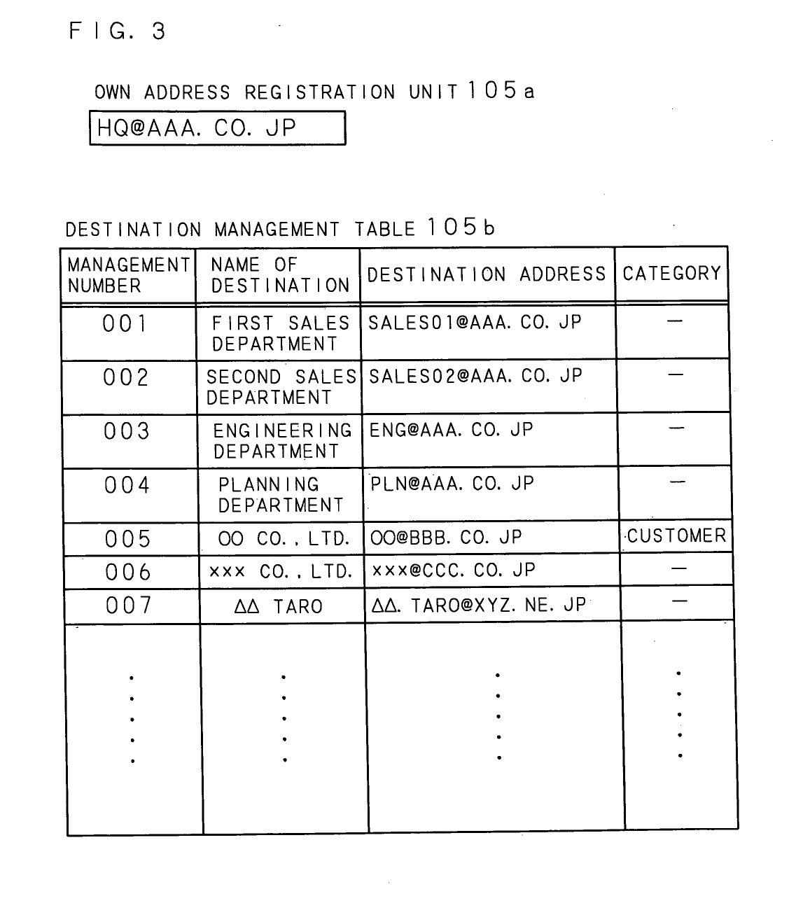

FIG. 3 is a conceptual diagram showing an example of the own address registration unit 105a and the destination management table 105b. Registered in the own address registration unit 105a is an email address for reception. In the example shown in FIG. 3, an email address of “HQ@AAA.CO.JP” is registered. As is well known, the part of “AAA.CO.JP” is a domain name wherein the part of “AAA” represents a domain representing an organization name, the part of “CO” represents a sub domain and the part of “JP” represents a top domain.

In the destination management table 105b, information such as a name of a destination, a destination address and a category is registered in association with each management number. The name of a destination is a name which is arbitrarily decided by the user of the digital multi-function peripheral 100. The destination address is an address for email reception used by the personal computer 200 on the local area network LN, the personal computer 300 and the Internet facsimile machine 400 on the Internet network IN, and the like. The name of a destination and the destination address are information to be entered through an operation panel 106. The example in FIG. 3 shows that a destination to which a name of “First Sales Department” is allocated is registered in association with an email address of“SALES01@AAA.CO.JP”. The same goes for other destinations. It should be noted that addresses having the same domain name as the digital multi-function peripheral 100 are used for the destinations of management numbers of “001” to “004”. Domain names, only organization names of which are different, are used for the destinations of management numbers of “005” and “006” and, furthermore, a category of “Customer” is set for the destination of the management number of “005”. A domain name, only a top domain of which is identical, is used for a destination of a management number of “007”.

It should be noted that a facsimile number, a data format for attachment to an email and the like may be registered in the destination management table 105b in addition to a name of a destination, a destination address and a category.

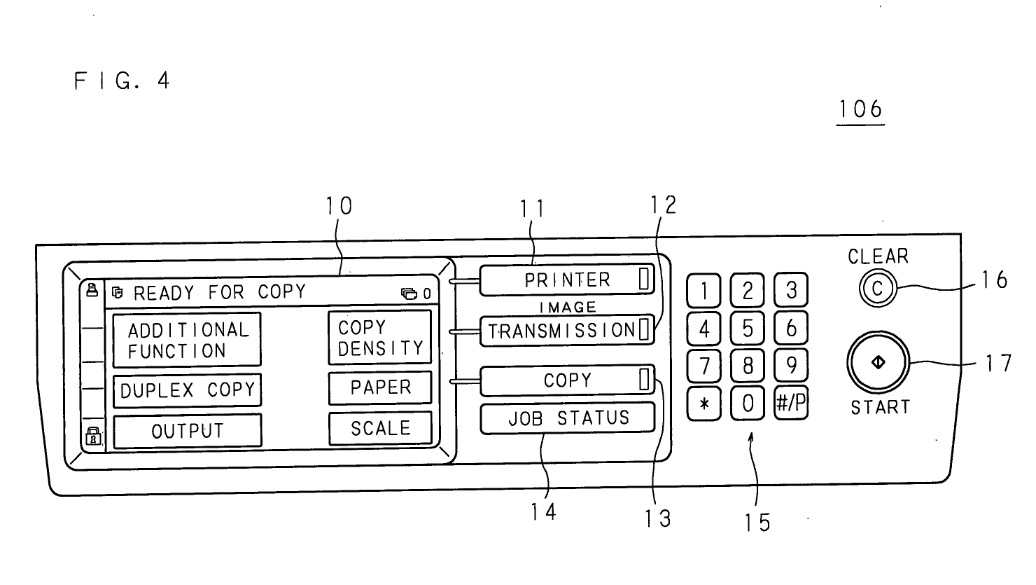

The operation panel 106 shown in the block diagram in FIG. 2 comprises an operation unit for accepting an operation by the user and a display unit for displaying information to be annunciated to the user (see FIG. 4). The operation unit comprises various kinds of operation keys for accepting a function switching operation or entering of the number of outputs in an output process, variable power in a copying process, a destination in a facsimile transmitting process and the like. The display unit comprises a liquid crystal display and displays the operating condition of the digital multi-function peripheral 100, the set point entered through the operation unit and the like. The liquid crystal display is also equipped with a touch panel so as to accept various kinds of selection operations by depressions by the user.

An image reading unit 107, which comprises an original copy table for mounting an original copy to be read, a light source for irradiating the original copy to be read with light, an image sensor such as a CCD (Charge Coupled Device), an AD converter and the like (not illustrated), provides an image of an original copy set at a predetermined reading position in the image sensor, converts the image into an analog electric signal and performs AD conversion for an obtained analog electric signal with an AD converter. Image data in digital format is generated by making corrections of the luminous intensity distribution characteristic of the light source at the time of reading of an original copy, sensitivity unevenness of the image sensor and the like for a digital signal obtained by AD conversion.

An image memory 108, which is a volatile page memory for example, temporarily stores image data obtained by the image reading unit 107, image data expanded from a print job, image data expanded from facsimile data and the like. Image data which is temporarily stored in the image memory 108 is transferred to a transfer destination which suits the purpose of use thereof by instruction of the CPU 101. That is, the image data is transmitted to an image forming unit 109 in order to form an image on paper or transmitted to an HDD 110 in order to save the data in the device using a filing function. Moreover, the image data is attached to an email including information of a destination address and then transferred to a communication IF 111 in order to transmit the data as an email or transferred to a facsimile modem 112 in order to transmit the data as facsimile data.

The image forming unit 109 forms an image on paper based on image data transferred from the image memory 108. Therefore, the image forming unit 109 comprises a charger for charging a photoconductor drum at a predetermined potential, a laser writing device for emitting a laser beam according to image data accepted from outside to generate an electrostatic latent image on the photoconductor drum, a developer for supplying the electrostatic latent image formed on the surface of the photoconductor drum with toner to make an image visible, a transfer element for transferring a toner image formed on the surface of the photoconductor drum onto paper and the like (not illustrated) and is constructed to form an image required by the user on paper by an electrophotographic method. It should be noted that an image may be formed by the ink jet method, the heat transfer method, the sublimation method or the like instead of image formation by the electrophotographic method using a laser writing device.

The HDD 110 is a hard disk device having a hard disk controller and a magnetic recording medium. A writing process or a reading process of data is achieved when the CPU 101 gives an instruction to the hard disk controller. A part of the storage area of the HDD 110 is used as a data area for storing image data, and image data stored in the data area is read out when a request is accepted through the operation panel 106. Accordingly, image data stored in the data area can be read out and a printing process can be executed when it is necessary to execute a printing process again due to failure of a printing process, shortage of the number of outputs or the like.

The communication IF 111 comprises an interface to be connected with the local area network LN. The digital multi-function peripheral 100 receives a print job and an email transmitted from the personal computer 200 on the local area network LN, an email transmitted from the personal computer 300 and the Internet facsimile machine 400 on the Internet network IN and the like via the communication IF 111. The digital multi-function peripheral 100 also transmits information, a notice of which is to be given upon reception of a print job from the personal computer 200, an email addressed to the personal computer 300 and the Internet facsimile machine 400 and the like via the communication IF 111. The communication IF 111 is constructed to control transmission and reception of such data of various kinds.

The facsimile modem 112 comprises a network termination circuit to be connected with the facsimile machine 500 via the facsimile communication network FN so as to transmit and receive facsimile data to and from the connected facsimile machine 500. Accordingly, the facsimile modem 112 comprises a decoding circuit for decoding received facsimile data and an encoding circuit for encoding facsimile data to be transmitted. The facsimile modem 112 executes an encoding process and a decoding process of such facsimile data and a transmitting/receiving process of encoded facsimile data.

For transmitting image data to outside using the digital multi-function peripheral 100, setting of a destination is accepted at the operation panel 106 first. FIG. 4 is a schematic view showing an example of the operation panel 106. The operation panel 106 shown in FIG. 4 has a display unit 10 provided with a liquid crystal panel and an operation unit provided with function switching keys 11 to 14 for switching a function, numeric keys 15 for entering a numeric, a Clear key 16 for clearing an entered set point and a Start key 17 for giving an instruction for initiation of a process. Moreover, a touch panel is placed on the liquid crystal panel of the display unit 10 so as to accept various kinds of selection operations through the touch panel.

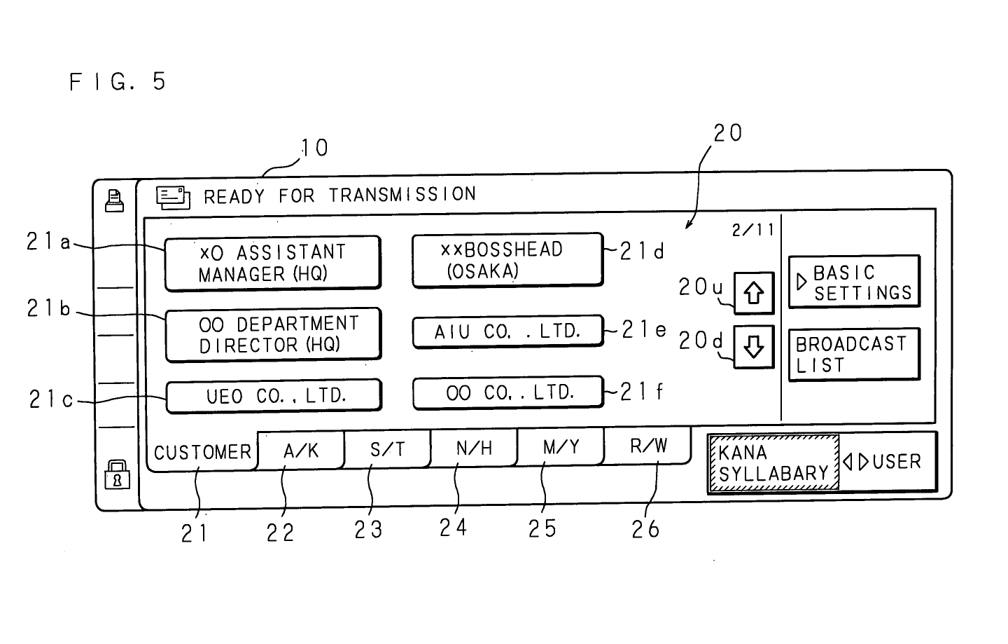

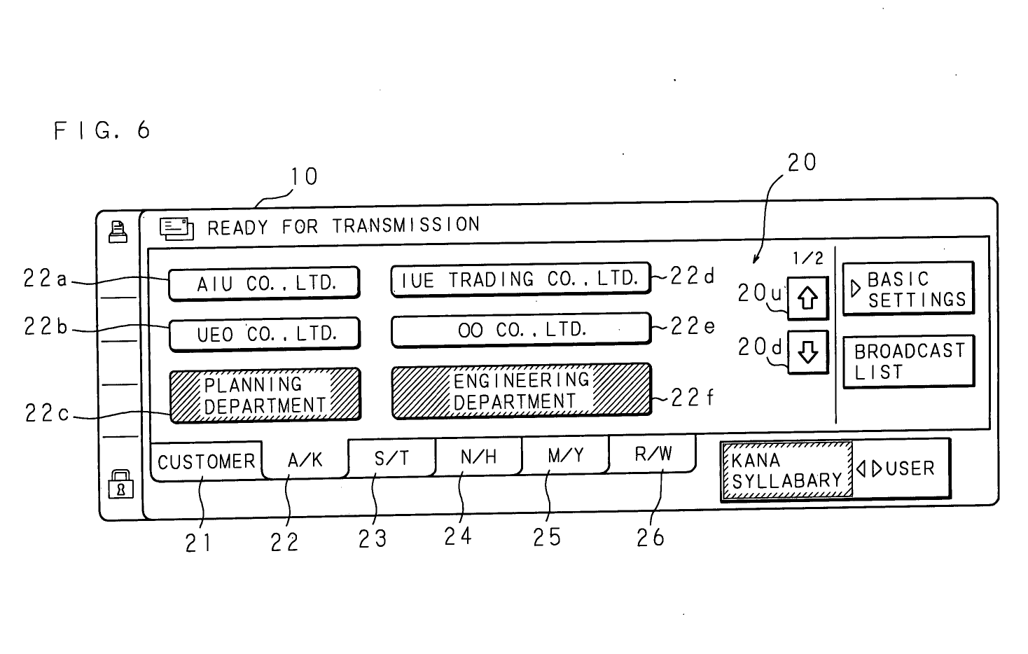

When a function switching key 12 at the operation panel 106 is depressed or when a predetermined operation is performed through the touch panel after the function switching key 12 is depressed, the digital multi-function peripheral 100 displays a screen at the display unit 10 to accept a destination of image data using a one-touch key. FIGS. 5 and 6 are schematic views showing examples of a destination setting screen to be displayed in setting of a destination using a one-touch key. Displayed at the destination setting screen 20 are one-touch keys, which are associated with respective destinations, divided into groups by the names of destinations. For example when a tag 21 is selected, displayed are one-touch keys 21a to 21f of destinations which are set as customers as shown in FIG. 5. Six one-touch keys are displayed at the destination setting screen 20 as one combination of choices, and the display range to be displayed can be switched by an operation of page switching keys 20u and 20d when there is a one-touch key that is not displayed, i.e., when there are seven one-touch keys or more. FIG. 6 similarly shows an example of display of a case where a tag 22 is selected. Six one-touch keys 22a to 22f, all of which have a name starting from “a”, “e”, “i”, “o”, “u” or “k”, are displayed and page switching keys 20u and 20d are placed on the right side of the screen in order to display a one-touch key which is not displayed. The same goes for a case where another tag 23 to 26 is selected.

For setting a destination through the destination setting screen 20, it is only necessary for the user to select and depress one or a plurality of one-touch keys displayed on the screen and it is unnecessary to enter characters in order to enter an email address of a destination. When a one-touch key is depressed, black/white reversing display is produced in order to differentiate a destination which is selected and a destination which is not selected. The destination setting screen 20 in FIG. 6 shows a state where destinations having names of “Planning Department” and “Engineering Department” are selected and destinations having names of “AIU Co., Ltd.”, “IUE Trading Co., Ltd.”, “UEO Co., Ltd.” and “OO Co., Ltd.” are not selected.

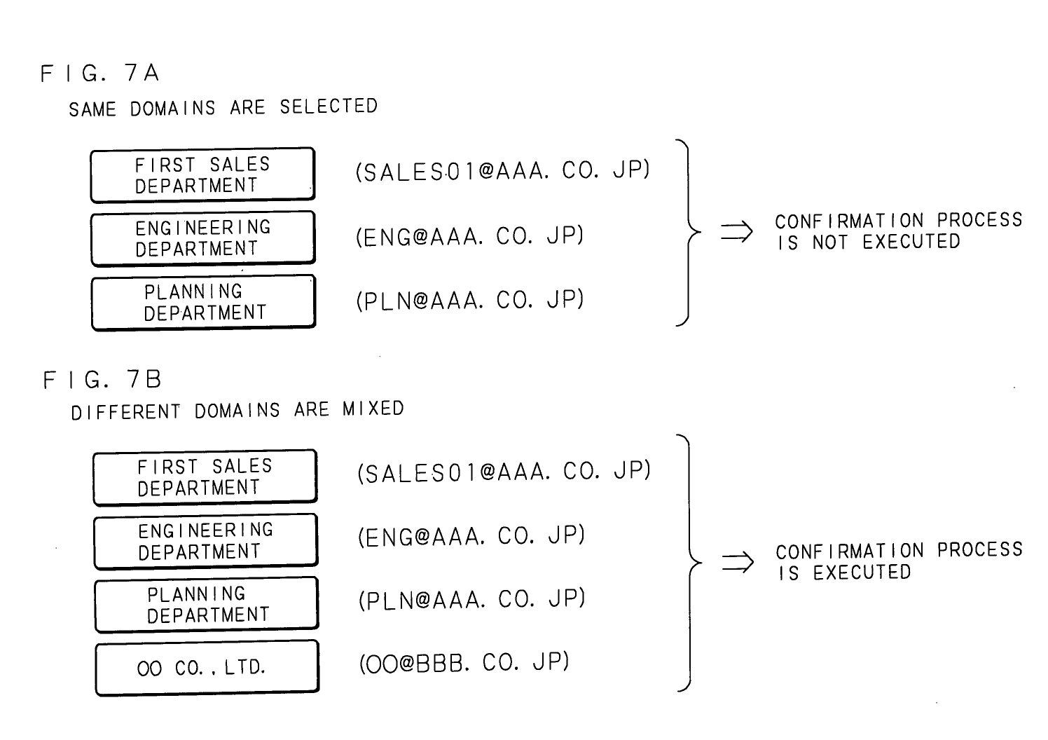

In the present embodiment, the relation between destinations is checked when a plurality of destinations are selected through the destination setting screen 20, and the digital multi-function peripheral 100 executes a confirmation process for causing the user to reconfirm the setting when the relation is not a relation which follows a preset rule. FIGS. 7A and 7B are explanatory views for explaining the operation of the digital multi-function peripheral 100 according to the present embodiment. In this example, the rule is that addresses having different domains are not mixed in the set destinations. Accordingly, the confirmation process is not executed when only destinations having the same domain-are selected as shown in FIG. 7A but is executed when different domains are mixed as shown in FIG. 7B. It should be noted that such a rule may be described in a control program-which is stored in the ROM 103 mentioned above. If a plurality of destinations are set, it becomes possible to determine whether destinations having different domain names are included or not when the control program extracts domain names of the respective destinations and compares the domain names with each other.

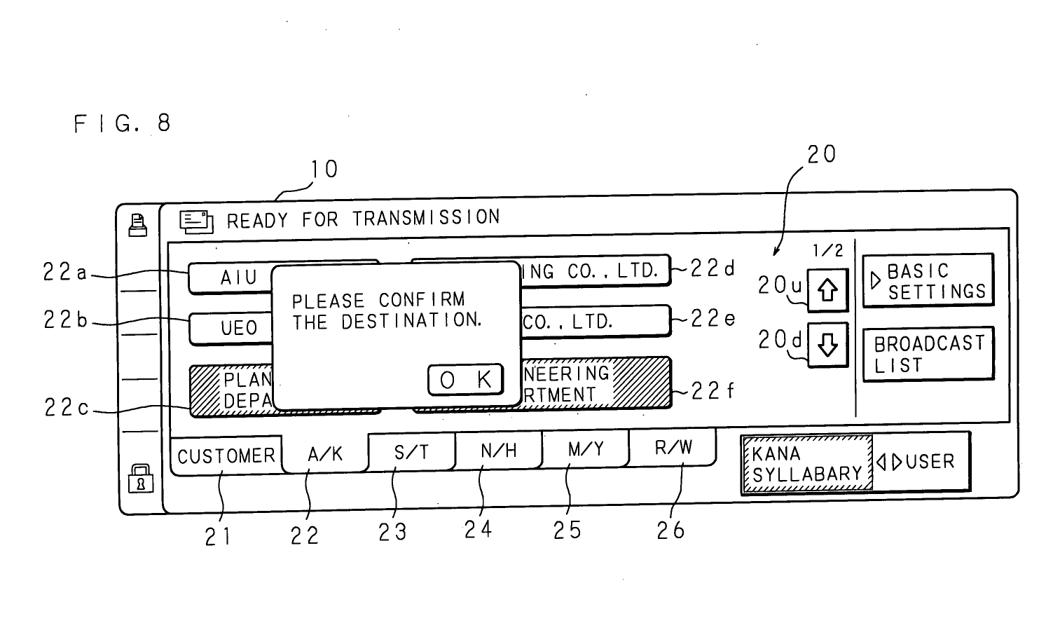

When it is necessary to cause the user to reconfirm the set destinations, the digital multi-function peripheral 100 executes a confirmation process by annunciating the fact. FIG. 8 is a schematic view for explaining an example of execution of a confirmation process. In the example shown in FIG. 8, a message dialog 30 is displayed over the destination setting screen 20. Displayed at the message dialog 30 is textual information of “Please confirm the destination.” Moreover, a confirmation button 31 placed as a software button is placed at the message dialog 30 and it is determined that the user has confirmed the destinations when the confirmation button 31 is depressed. When the confirmation button 31 is depressed, the message dialog 30 is erased.

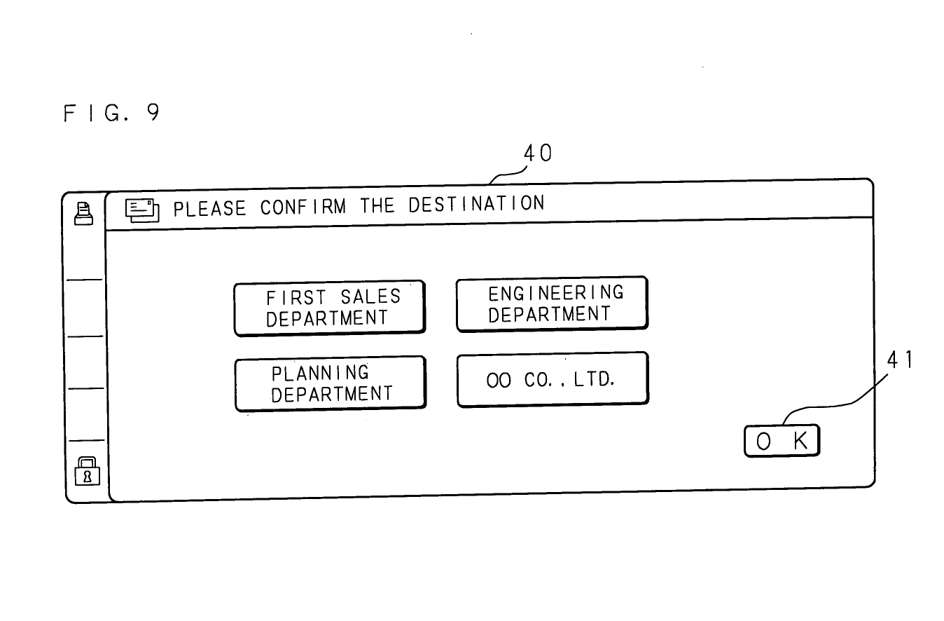

Instead of displaying the message dialog 30 shown in FIG. 8, a destination to be confirmed may be displayed explicitly. FIG. 9 is a schematic view for explaining another example of execution of a confirmation process. In a confirmation screen 40 shown in FIG. 9, names of all the destinations selected at the destination setting screen 20 are displayed and highlighting is performed to clearly express that destinations having different domains are included. In the destination management table 105b shown in FIG. 3, three destinations of “First Sales Department”, “Engineering Department” and “Planning Department” have the same domain name and only “OO Co., Ltd.” has a different domain name. Accordingly, when these four destinations are selected, only “OO Co., Ltd.” is displayed in black/white reversing display or color display so as to clearly express a destination to be confirmed. Moreover, a confirmation button 41 placed as a software button is placed at the confirmation screen 40 and it is determined that the user has confirmed the destinations when the confirmation button 41 is depressed. When the confirmation button 41 is depressed, the display is returned to the destination setting screen 20 while maintaining the selection by the user.

It should be noted that each one of the message dialog 30 explained with reference to FIG. 8 and the confirmation screen 40 explained with reference to FIG. 9 may be displayed by the device or they may be used arbitrarily. For example, the confirmation screen 40 may be displayed by default, and the message dialog 30 may be displayed when the number of destinations having a domain name becomes equal to the number of destinations having another domain name and, therefore, destinations to be highlighted cannot be decided by the device.

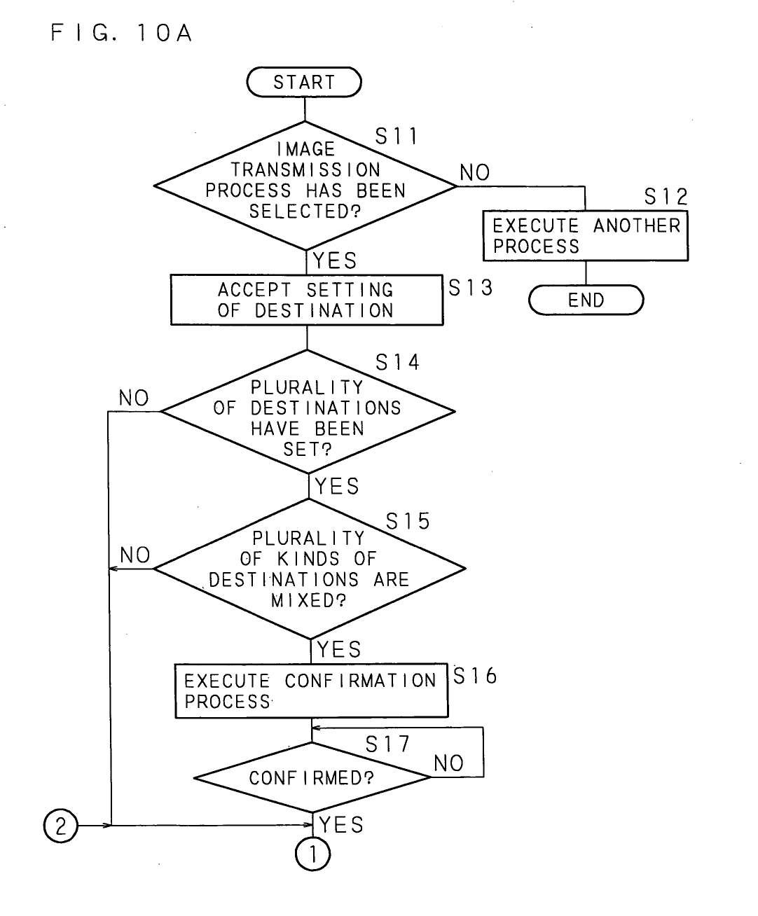

The following description will explain the operation of the digital multi-function peripheral 100 in execution of image transmission. FIGS. 10A and 10B are a flow chart for explaining the process procedure of the digital multi-function peripheral 100. The CPU 101 of the digital multi-function peripheral 100 first determines whether an image transmission process has been selected or not based on information entered through the operation panel 106 (step S11). Whether an image transmission process has been selected or not is determined by determining whether the function switching key 12 at the operation panel 106 has been depressed or not. When it is determined that an image transmission process has not been selected (S11: NO), the CPU 101 executes another process (step S12).

When it is determined that an image transmission process has been selected (S11: YES), the CPU 101 accepts setting of a destination by displaying the destination setting screen 20 shown in FIG. 5 at the display unit 10 of the operation panel 106 (step S13). The CPU 101 then determines whether a plurality of destinations have been set at the destination setting screen 20 or not (step S14). Whether a plurality of destinations have been set or not is determined by determining whether a plurality of one-touch keys at the destination setting screen 20 have been depressed or not.

When it is determined that a plurality of destinations have been set (S14: YES), the CPU 101 determines whether a plurality of kinds of destinations are mixed or not (step S15). Whether a plurality of kinds of destinations are mixed or not is determined by comparing domain names of the respective set destinations. When it is determined that a plurality of kinds of destinations are mixed (S15: YES), the CPU 101 executes a confirmation process by displaying the message dialog 30 shown in FIG. 8 or the confirmation screen 40 shown in FIG. 9 (step S16).

The CPU 101 then determines whether the user has confirmed the destination or not (step S17). Whether the destinations has been confirmed or not is determined by determining whether the confirmation button 31 at the message dialog 30 has been depressed or not or determining whether the confirmation button 41 at the confirmation screen 40 has been depressed or not. In practice, since a transmission process is not initiated promptly even when the confirmation button 31 (or confirmation button 41) is depressed and the device waits until a transmission initiation instruction is given in the next step, the user can reconfirm the destination in this period and correct the destination when there is a mistake.

When it is determined that the destination has not been confirmed (S17: NO), the CPU 101 waits until the destination is confirmed. The CPU 101 determines whether a transmission initiation instruction has been given or not (step S18) when it is determined in the step S17 that the destination has been confirmed (S17: YES), when it is determined in the step S14 that one destination has been set (S14: NO) and when it is determined in the step S15 that a plurality of kinds of destination are not mixed (S15: NO). Whether a transmission initiation instruction has been given or not is determined by determining whether the Start key 17 at the operation panel 106 has been depressed or not. When it is determined that a transmission initiation instruction has not been given (S18: NO), the device waits until a transmission initiation instruction is given.

When it is determined that a transmission initiation instruction has been given (S18: YES), the digital multi-function peripheral 100 reads an original copy image (step S19) and generates send data based on the read image data (step S20). In particular, the digital multi-function peripheral 100 generates an email addressed to a destination set at the destination setting screen 20 and attaches the read image data to the generated email. A transmission process is then executed by transmitting the generated send data (email) from the communication IF 111 (step S21).

With the present embodiment, as described above, it becomes possible to prevent leakage of information to an unexpected place by adding a confirmation step when a mistake may possibly be included in a plurality of set destinations.

It should be noted that, although whether a plurality of kinds of domain names are mixed or not is determined in the example shown in FIGS. 7A and 7B by comparing all the domain names, whether a plurality of kinds of domain names are mixed or not may be determined by paying notice to a part of the domain names.

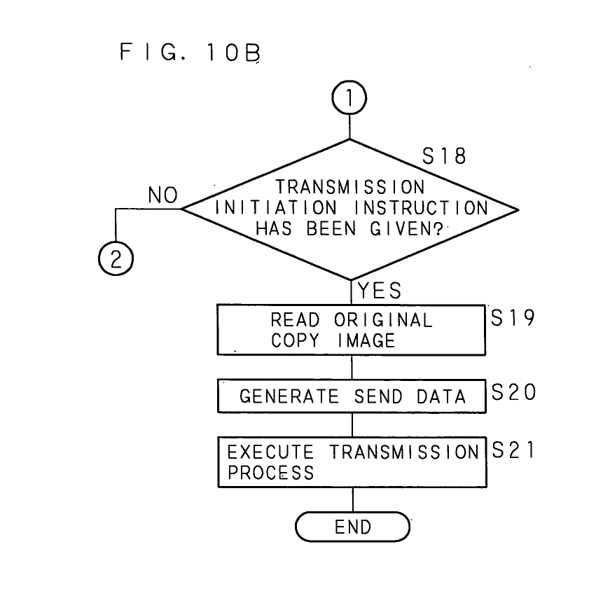

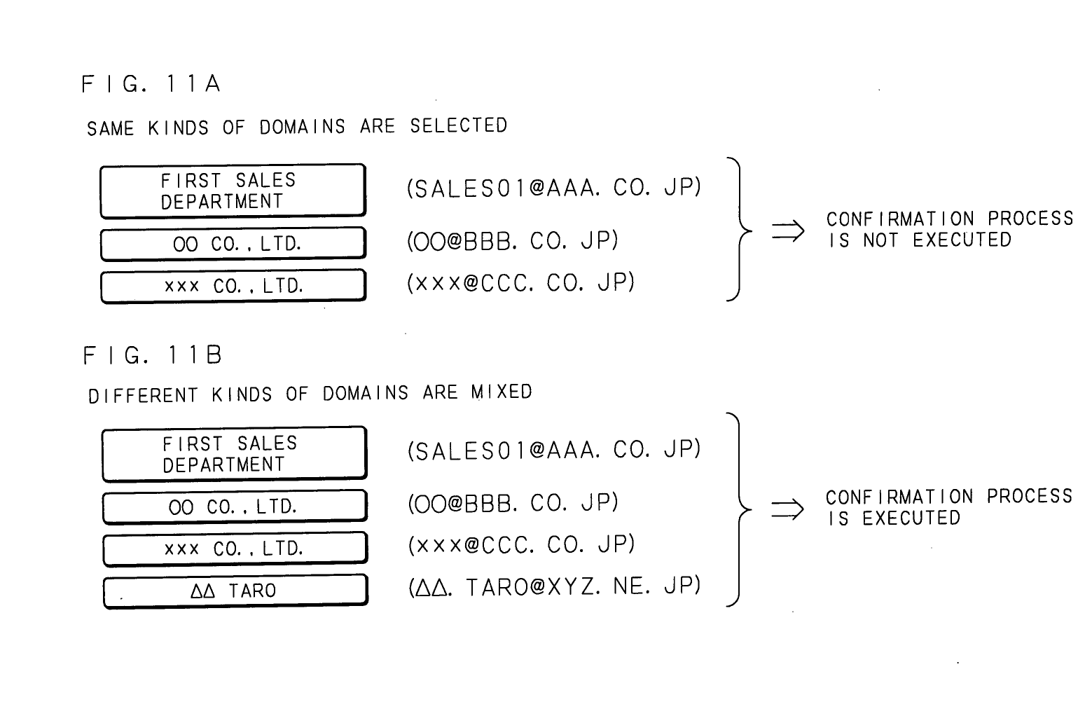

FIGS. 11A and 11B are explanatory views for explaining another example of criterion. In this example, the domain names representing the organization names are left out of consideration and the rule is that different domain names are not mixed in the sub domains and the top domains. Accordingly, a confirmation process is not executed when all the selected destinations have the same sub domain and the same top domain as shown in FIG. 11A but is executed when destinations having different sub domains are included in the selected destinations.

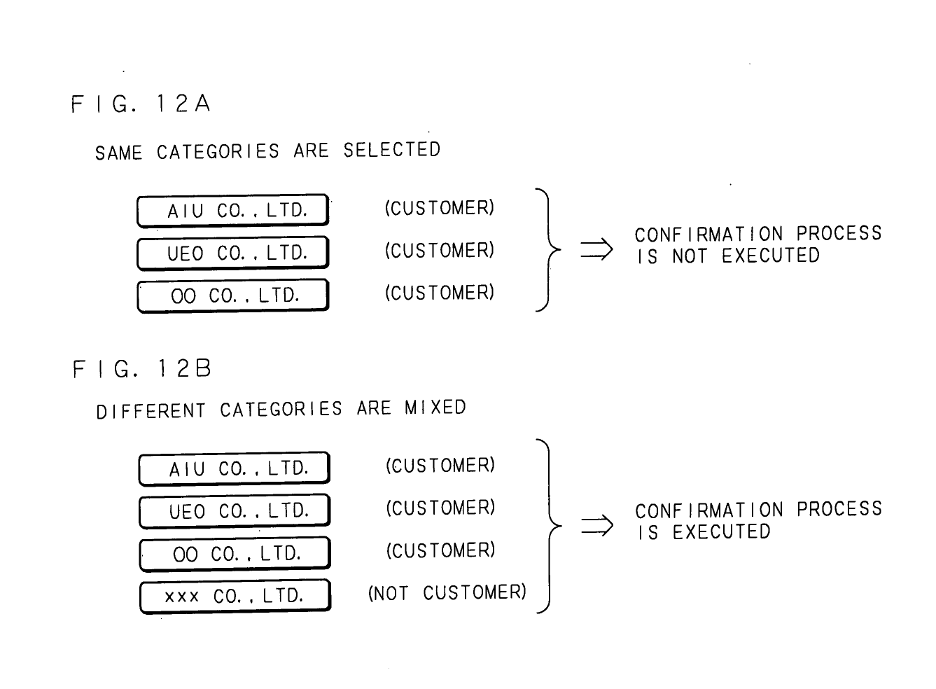

Moreover, whether different kinds of destinations are included or not may be determined based on set categories since categories are set in addition to names of destinations and destination addresses in the destination management table 105b. FIGS. 12A and 12B are explanatory views for explaining another example of criterion. In this example, the rule is that destinations of different categories are not included. Accordingly, a confirmation process is not executed when the selected destinations belong to the same category as shown in FIG. 12A but is executed when destinations belonging to different categories are included in the selected destinations as shown in FIG. 12B.

Embodiment 2

Although the Embodiment 1 is constructed to determine whether destinations are a combination of destinations which follows a preset rule or not when a plurality of destinations are set and prompt confirmation to the user when the destinations do not follow the rule, determination may be made by comparing an email address used by the digital multi-function peripheral 100 (i.e., an email address of source) and an email address set as a destination.

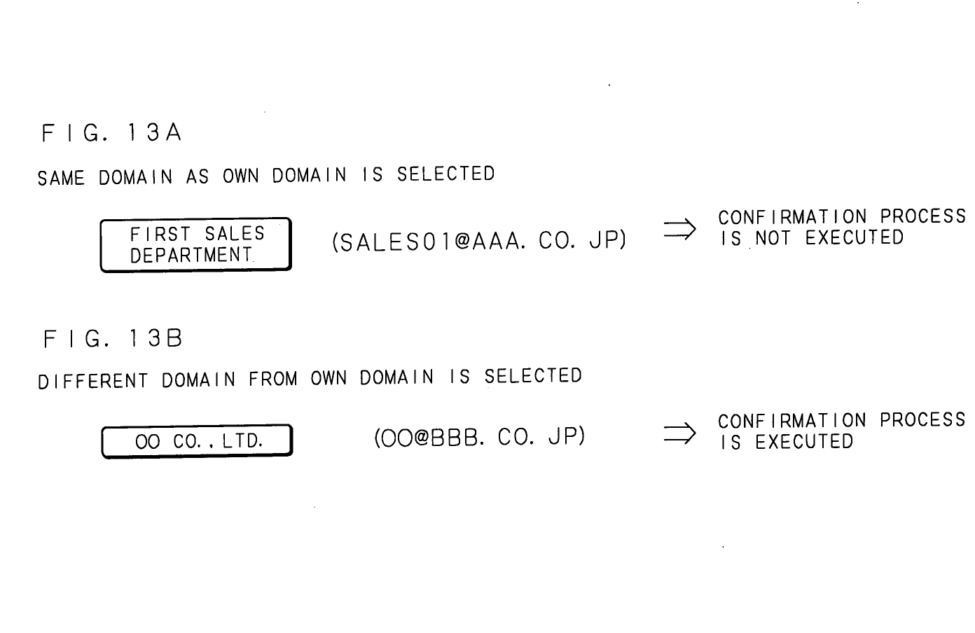

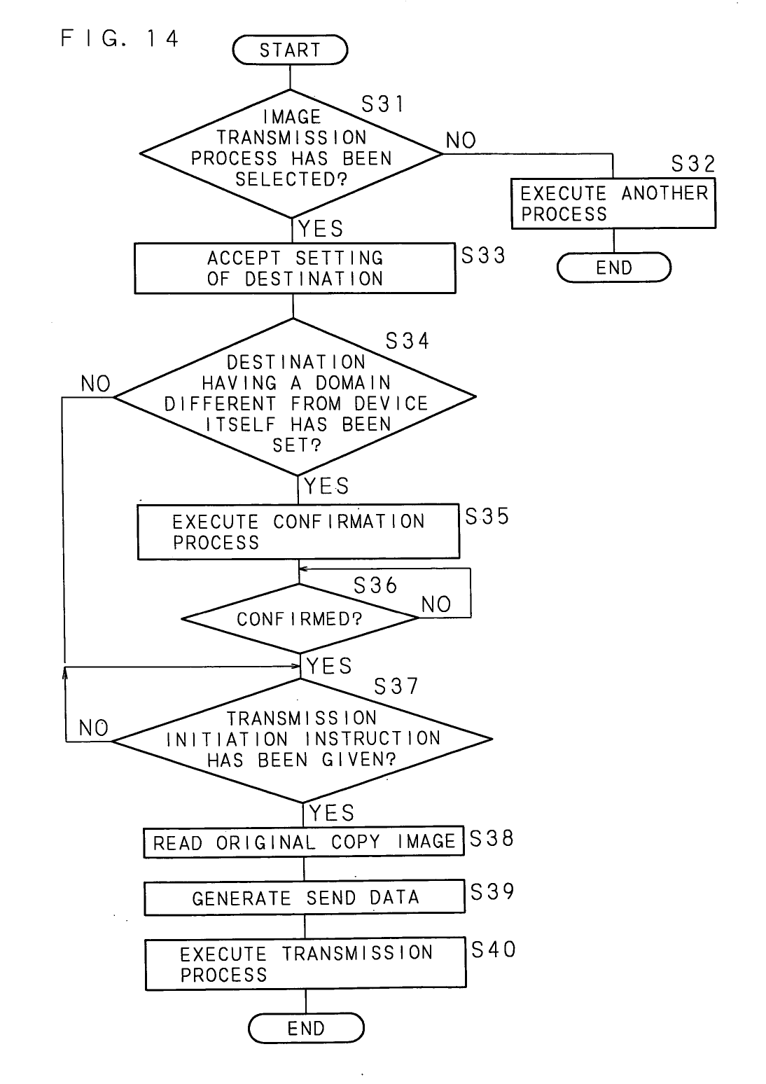

FIGS. 13A and 13B are explanatory views for explaining the operation of the digital multi-function peripheral 100 according to the present embodiment. In this example, the rule is that the domain name of a set destination is identical to the domain name of an email address set for the device itself (digital multi-function peripheral 100). Accordingly, a confirmation process is not executed when the domain name of a set destination is identical to the domain name of the device itself as shown in FIG. 13A but is executed when the domain name of the set destination is different-from the domain name of the device itself as shown in FIG. 13B.

FIG. 14 is a flow chart for explaining the process procedure of the digital multi-function peripheral 100. The CPU 101 of the digital multi-function peripheral 100 first determines whether an image transmission process has been selected or not based on information entered through the operation panel 106 (step S31). When it is determined that an image transmission process has not been selected (S31: NO), the CPU 101 executes another process (step S32). When it is determined that an image transmission process has been selected (S31: YES), the CPU 101 accepts setting of a destination by displaying the destination setting screen 20 shown in FIG. 5 at the display unit 10 of the operation panel 106 (step S33).

After accepting the setting of a destination, the CPU 101 determines whether a destination having a domain different from the device itself has been set or not (step S34). The CPU 101 can determine whether a destination having a domain different from the device itself has been set or not by comparing a domain name of an email address registered in the own address registration unit 105a and a domain name of a destination which is set using a one-touch key. When it is determined that a destination having a domain name different from the device itself has been set (S34: YES), the CPU 101 executes a confirmation process by displaying the message dialog 30 shown in FIG. 8 at the display unit 10 (step S35).

The CPU 101 then determines whether the user has confirmed the destination or not (step S36). When it is determined that the destination has not been confirmed (S36: NO), the CPU 101 waits until the destination is confirmed. The CPU 101 determines whether a transmission initiation instruction has been given or not (step S37) when it is determined in the step S36 that the destination has been confirmed (S36: YES) and when it is determined in the step S34 that a destination having the same domain as the device itself has been set (S34: NO). When it is determined that a transmission initiation instruction has not been given (S37: NO), the CPU 101 waits until a transmission initiation instruction is given.

When it is determined that a transmission initiation instruction has been given (S37: YES), the digital multi-function peripheral 100 reads an original copy image (step S38) and generates send data based on the read image data (step S39). In particular, the digital multi-function peripheral 100 generates an email addressed to a destination set at the destination setting screen 20 and attaches the read image data to the generated email. The digital multi-function peripheral 100 then executes a transmission process by transmitting the generated send data (email) from the communication IF 111 (step S40).

With the present embodiment, as described above, it becomes possible to prevent leakage of information to an unexpected place by adding a confirmation step when a set destination may possibly be improper.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. An image data transmitting apparatus comprising:
a transmission unit for transmitting image data to outside; and
a controller capable of performing operations of;
setting one or a plurality of destinations of image data to be transmitted by the transmission unit;
determining whether a set destination is a destination which follows a predetermined rule or not; and
notifying that the set destination is not a destination which follows the rule when it is determined that the set destination is not a destination which follows the rule.

2. The image data transmitting apparatus according to claim 1, wherein the transmission unit transmits image data using destination and source addresses including domain names and the rule is that a communication address of a set destination does not include a domain name different from that of a source.

3. The image data transmitting apparatus according to claim 1, further comprising:
a storage unit for storing a name assigned to each destination in association with a communication address of each destination;
a display unit for displaying a plurality of names of destinations; and
an accepting unit for accepting selection of one or a plurality of names from displayed names of destinations,
wherein said controller is further capable of setting a communication address associated with a name of a selected destination as a destination.

4. An image data transmitting apparatus comprising:
a transmission unit for transmitting image data to outside; and
a controller capable of performing operations of:
setting one or a plurality of destinations of image data to be transmitted by the transmission unit;
determining whether a plurality of destinations have been set or not;
determining whether set destinations are a combination which follows a predetermined rule or not when it is determined that a plurality of destinations have been set; and
notifying that the set destinations are not a combination which follows the rule when it is determined that the set destinations are not a combination which follows the rule.

5. The image data transmitting apparatus according to claim 4, wherein the transmission unit transmits image data using destination and source addresses including domain names and the rule is that a communication address of a set destination does not include a domain name different from that of a source.

6. The image data transmitting apparatus according to claim 4, wherein the transmission unit transmits image data using destination addresses including domain names and the rule is that set destinations do not include different kinds of domain names.

7. The image data transmitting apparatus according to claim 4, wherein the transmission unit transmits image data using an email address and the rule is that set destinations do not include different kinds of domain names.

8. The image data transmitting apparatus according to claim 4, further comprising:
a storage unit for storing a name assigned to each destination in association with a communication address of each destination;
a display unit for displaying a plurality of names of destinations; and
an accepting unit for accepting selection of one or a plurality of names from displayed names of destinations,
wherein said controller is further capable of setting a communication address associated with a name of a destination selected at the accepting unit as a destination.

9. The image data transmitting apparatus according to claim 4, further comprising a display unit for displaying textual information indicating that a set destination is to be confirmed.

10. The image data transmitting apparatus according to claim 4, further comprising a display unit for explicitly displaying a destination to be confirmed.

11. The image data transmitting apparatus according to claim 4, further comprising a reading unit for reading an image of an original copy,
wherein said controller is further capable of performing operations of:
generating an email including image data obtained by the reading unit; and
transmitting a generated email to a set destination.

12. An image data transmitting apparatus comprising:
transmitting means for transmitting image data to outside;
setting means for setting one or a plurality of destinations of image data to be transmitted by the transmitting means;
means for determining whether a set destination is a destination which follows a predetermined rule or not; and
notifying means for notifying that the set destination is not a destination which follows the rule when it is determined that the set destination is not a destination which follows the rule.

13. The image data transmitting apparatus according to claim 12, wherein the transmitting means transmits image data using destination and source addresses including domain names and the rule is that a communication address of a set destination does not include a domain name different from that of a source.

14. The image data transmitting apparatus according to claim 12, further comprising:
means for storing a name assigned to each destination in association with a communication address of each destination;
means for displaying a plurality of names of destinations; and
means for accepting selection of a name or names of one or a plurality of destinations from displayed names of destinations,
wherein a communication address associated with a name of a selected destination is set as a destination.

15. An image data transmitting apparatus comprising:
transmitting means for transmitting image data to outside;
setting means for setting one or a plurality of destinations of image data to be transmitted by the transmitting means;
means for determining whether a plurality of destinations have been set by the setting means or not;
means for determining whether set destinations are a combination which follows a predetermined rule or not when it is determined that a plurality of destinations have been set; and
notifying means for notifying that the set destinations are not a combination which follows the rule when it is determined that the set destinations are not a combination which follows the rule.

16. The image data transmitting apparatus according to claim 15, wherein the transmitting means transmits image data using destination and source addresses including domain names and the rule is that a communication address of a set destination does not include a domain name different from that of a source.

17. The image data transmitting apparatus according to claim 15, wherein the transmitting means transmits image data using a destination address including a domain name and the rule is that set destinations do not include different kinds of domain names.

18. The image data transmitting apparatus according to claim 15, wherein the transmitting means transmits image data using an email address and the rule is that set destinations do not include different kinds of domain names.

19. The image data transmitting apparatus according to claim 15, further comprising:
means for storing a name assigned to each destination in association with a communication address of each destination;
means for displaying a plurality of names of destinations; and
means for accepting selection of a name or names of one or a plurality of destinations from displayed names of destinations,
wherein a communication address associated with a name of a selected destination is set as a destination.

20. The image data transmitting apparatus according to claim 15, wherein the notifying means has means for displaying textual information indicating that a set destination is to be confirmed.

21. The image data transmitting apparatus according to claim 15, wherein the notifying means has means for explicitly displaying a destination to be confirmed.

22. The image data transmitting apparatus according to claim 15, further comprising:
reading means for reading an image of an original copy; and
means for generating an email including image data obtained by the reading means,
wherein a generated email is transmitted to a set destination.
